(19) United States
(12) Patent Application Publication
(10) Pub. No.: US 2025/0155261 A1
(43) Pub. Date: May 15, 2025

(54) SYSTEM AND METHOD FOR DETERMINATION OF TRAFFIC FLOW INFORMATION USING EXTERNAL DATA

(71) Applicant: SCHREDER ILUMINAÇAO AS, Carnaxide (PT)

(72) Inventors: Michael STEURER, Carnaxide (PT); Lourenço BANDEIRA, Carnaxide (PT)

(21) Appl. No.: 18/839,210

(22) PCT Filed: Feb. 20, 2023
(86) PCT No.: PCT/EP2023/054219

§ 371 Date: Aug. 16, 2024

(30) Foreign Application Priority Data
Feb. 18, 2022 (NL) 2031012

(51) Int. Cl. G01C 21/00; G08G 1/01; G08G 1/04; G08G 1/052

(52) U.S. Cl. CPC G01C 21/3841; G08G 1/0129; G08G 1/04; G08G 1/052

(57) ABSTRACT

A system for determination of traffic flow information in an area comprising a traffic surface, such as a road surface or a pedestrian surface, said system comprising a sensing means configured to sense a sequence of signals over time related to the area, and a processing means configured to receive the sensed sequence of signals over time and optionally external data related to the area, detect moving objects in the area based on the sensed sequence of signals over time, and determine traffic flow information related to said moving objects in the sensed sequence of signals over time optionally using the external data.

### CROSS-REFERENCE TO RELATED APPLICATIONS

This application is a U.S. National Phase of International Patent Application No. PCT/EP2023/054219 filed Feb. 20, 2023, which claims priority to Netherlands Patent Application No. 2031012 filed Feb. 18, 2022, the disclosures of each of which are incorporated by reference in their entirety herein.

### FIELD OF INVENTION

The field of the invention relates to a system and a method for determination of traffic flow information in an area comprising a traffic surface, such as a road surface or a pedestrian surface. Other particular embodiments relate to one or more luminaires comprising said system, and more particularly to a network of outdoor luminaires comprising said system.

### BACKGROUND

Traffic monitoring systems are typically configured to detect and monitor moving objects such as vehicles passing in a monitored area. This is usually achieved through cameras providing monocular imagery data and object tracking algorithms. However, it may be difficult for those algorithms to determine traffic flow information accurately for some angles and perspectives of the camera. Moreover, those traffic monitoring systems are not able to determine the speed of monitored moving objects from the provided monocular imagery data.

Despite the activity in the field, there remains an unaddressed need for overcoming the above problems. In particular, it would be desirable to achieve a more precise monitoring of vehicles and/or other moving objects, preferably within a lane, through a traffic monitoring system. Also, it would be desirable to determine the speed of vehicles and/or other moving objects passing in the monitored area through the traffic monitoring system.

### SUMMARY

An object of embodiments of the invention is to provide a system and a method for determination of traffic flow information in an area comprising a traffic surface, such as a road surface or a pedestrian surface, which allows for a more reliable and precise determination of the traffic flow information in said area at low cost. Such improved system and method may be used to assess traffic behavior or traffic issues, in particular in a lane, with more confidence.

A further object of embodiments of the invention is to provide one or more luminaires comprising said system, and in particular to provide a network of outdoor luminaires comprising said system.

According to a first aspect of the invention, there is provided a system for determination of traffic flow information in an area comprising a traffic surface, such as a road surface or a pedestrian surface. The system comprises a sensing means and a processing means. The sensing means is configured to sense a sequence of signals over time related to the area. The processing means is configured to receive the sensed sequence of signals over time and optionally external data related to the area, detect moving objects in the area based on the sensed sequence of signals over time, and determine traffic flow information related to said moving objects in the sensed sequence of signals over time optionally using the external data.

An inventive insight underlying the first aspect is that, by using external data related to the area, an accuracy of the determined traffic flow information may be improved. Indeed, the accuracy of the determined traffic flow information may depend on external factors that may not be present or easily available in the sensed sequence of signals over time. Thus, using external data in addition to the sensing of said sequence of signals over time allows for an improvement of the accuracy in the determination of the traffic flow information in the sequence of signals over time for a broader range of situations. Moreover, this will allow implementing a local solution at low cost.

Another inventive insight underlying the first aspect is that the accuracy of the determined traffic flow information may also be improved without using the external data related to the area. Indeed, the accuracy of the determined traffic flow information may also depend on data that may be present or easily available in the sensed sequence of signals over time. Thus, using signal processing techniques in addition to the sensing of said sequence of signals over time also allows for an improvement of the accuracy in the determination of the traffic flow information in the sequence of signals over time. In an example, a density of pixels may be analyzed by applying image processing techniques to a sequence of images over time sensed by an image sensing means, such as a camera or the like, and the traffic flow information may be determined based on the analyzed density of pixels. In another example, a density of sounds may be analyzed by applying sound processing techniques to a sequence of sounds over time sensed by a sound sensing means, such as a microphone or the like, and the traffic flow information may be determined based on the analyzed density of sounds. It should be clear to the skilled person that signal processing techniques may be applied to other kinds of signals in the sensed sequence of signals over time.

The term “traffic flow information” may refer to any kind of data related to the traffic flow of objects, such as any one of the following or a combination thereof: number of objects in the flow, speed of objects in the flow, direction of objects in the flow, flow distribution properties (e.g. multiple vehicle flows in distinct lanes), properties of the objects in the flow (e.g. properties of a vehicle or a person of the flow, type of object, license plate of a vehicle, etc.), trajectory of objects in the flow, or particular (deviant, divergent) behavior of one or more objects in the flow in comparison with the remaining part of the objects in the flow (e.g. particular direction and/or speed of one or more vehicles in a vehicular traffic flow, such as ghost drivers or the like, one or more persons not wearing a face mask in a pedestrian traffic flow of persons wearing a face mask, etc.).

According to the invention, the traffic surface may correspond to any space intended to sustain vehicular and/or pedestrian traffic, such as a road surface ((sub) urban streets or boulevards, roads, highways, countryside roads or paths, etc.), a biking or skating surface (bikeways, skateparks, ways dedicated to light electric vehicles (LEVs), micro-EVs, etc.), a pedestrian surface (public places, markets, parks, pathways, sidewalks, zebra crossings, etc.), a railway surface (railways tracks for trams, trains, etc.), an aerial surface (airways for drones, unmanned aerial vehicles (UAVs), etc.), or a water surface (waterways for boats, jet skis, etc.). The traffic surface may comprise at least one lane, wherein a lane of the at least one lane may have a type comprising: a travel direction and/or one or more traffic surface markings (e.g. an arrow road marking, a bus-only lane, a one-way lane, etc.). In addition, the travel direction associated to one or more lanes of the at least one lane may change depending on certain conditions. For example, the travel direction associated to a lane may be reversed by a road authority on a schedule (predefined or not) in order to dynamically handle changes in the traffic flow and to maintain a fluid flow of traffic on the traffic surface. Typically, a lane is a lane in which vehicles circulate, but it could also be a lane such as a zebra crossing lane or sidewalk in which pedestrians are circulating.

According to an exemplary embodiment, the processing means is configured to determine traffic flow information by determining a model, optionally based on the external data, and determining the traffic flow information related to said moving objects in the sensed sequence of signals over time using the model. In that manner, external data may optionally be used to determine the model and the model may be used to determine traffic flow information. As long as the optional external data is not substantially modified the same model may be used. By “model”, it is meant in the context of the invention a processing model used to process the sensed data.

It should be clear to the skilled person that the model may alternatively or additionally be based on data that may be present or easily available in the sensed sequence of signals over time, by applying signal processing techniques to the sensed sequence of signals over time. In that manner, said data may alternatively or additionally be used to determine the model and the model may be used to determine traffic flow information.

According to a preferred embodiment, the processing means may be configured to receive new and/or updated optional external data related to the area and to update the model based on the new and/or updated optional external data. In that manner, the model remains valid until new and/or updated optional external data are available to update the model. According to an exemplary embodiment, the model may be updated on a regular basis.

According to an exemplary embodiment, the sensing means may comprise any one of the following: an image capturing means configured to capture a sequence of images, such as a visible light camera or a thermal camera, a LIDAR configured to capture a sequence of point clouds, a radar, a receiving means with an antenna configured to capture a sequence of signals, in particular a sequence of short-range signals, such as Bluetooth signals, a sound capturing means, or a combination thereof. The processing means may be included in the sensing means, may be located in a position adjacent to that of the sensing means, or may be located at a location which is remote from that of the sensing means. According to exemplary embodiments wherein the sensing means comprises a sound capturing means and/or a receiving means with an antenna, the location from which the signal originates may be derived from the received sequence of signals over time, e.g., using signal strength of the received sequence of signals over time. According to another exemplary embodiment, sensed sequence of signals over time by a plurality of sensing means, e.g. two antennas located on either side of a road surface, may be combined. In that manner, the accuracy of the derived location from which the signal originates may be improved. Additionally, it may make it possible to determine additional information not achievable by measurements performed by a single sensing means, such as determining occlusions between vehicles, e.g. by comparing the received signal strength with the expected signal strength when the signal is received from the same distance but without occlusions. When multiple sensing means are used for the same area, preferably the system is configured to provide synchronization between the multiple sensing means.

According to an exemplary embodiment, the sensing means may be configured to sense signals of the sequence of signals over time at consecutive time intervals, preferably at least two signals per second, more preferably at least 10 signals per second. The sensing means may be set according to a sensing profile. The sensing profile may correspond to a set of times (predefined or not) at which the sensing means is instructed to sense signals related to the area. In an exemplary embodiment, the sensing profile of the sensing means may be set to sense signals at regular time intervals. In another exemplary embodiment, the sensing profile may be set and/or modified dynamically depending on the real-time traffic situation, in particular on the real-time traffic situation on the traffic surface, or depending on other parameters such as the hour of the day (e.g. traffic jams are known to occur at a specific time period on a specific road surface), a specific time/season of the year, a size of the traffic surface (e.g. a small one-way road or a multiple-lane highway), a geographic location of the area and/or traffic surface (e.g. inside a city, in a suburban area, or at the countryside), a type of a lane of the traffic surface (a vehicle lane, a pedestrian lane, a bicycle lane, a one-way lane, a two-way lane, etc.), etc. Similarly, in view of the above, the processing means may be set according to a processing profile.

According to a preferred embodiment, the sensing means comprises an image capturing means configured to capture a sequence of images related to the area at consecutive time intervals, preferably at least two frames per second, more preferably at least 10 frames per second, said sequence of images preferably comprising images of at least one lane of the road surface and/or images of the pedestrian surface, for example of at least one lane of the pedestrian surface.

According to an exemplary embodiment, the external data may comprise any one or more of the following: a map comprising the area, in particular the traffic surface (e.g. including a scale indicated on the map, that may be used to estimate dimensions or distances) and/or a layout of the area, in particular of the traffic surface (e.g. crossroads intersection, pedestrian crossing, etc.) and/or information pertaining to the area, in particular to at least one lane of the traffic surface (e.g. number of lanes, type of a lane such as lane restricted to busses and/or bikes and/or electric cars, etc.), a geographic location of the area (name of district, name of city, name of region, name of country, etc.), a type of the area (e.g., urban area, suburban area, countryside area, etc.), a geographic location of street furniture (e.g. benches, streetlamps, traffic lights, bus or tram stops, taxi stands, etc.) in the area, an average speed of vehicles in one or more of the at least one lane of the road surface, real-time traffic, real-time information pertaining to traffic lights (e.g. traffic light color, time before switching to another color, etc.), information pertaining to traffic laws in the area (e.g., driving on the left in the UK and on the right in the EU or US, maximum speed limits per type of area and/or per country or region inside a given country, regulations regarding UAVs), information pertaining to regulations for persons in the area (e.g. wearing a face mask, staying at a distance from another person, etc.), information pertaining to a type of landscape in the area (type of buildings in the surroundings of the traffic surface such as schools, hospitals, residential area, shopping area), weather data (e.g. snow, rain, etc.), road surface condition data (wet, ice, etc.), data pertaining to a visibility condition (fog, etc.), data pertaining to a noise/sound level in the area, a time schedule of objects passing in the area such as a time schedule of public transportation, information pertaining to symptoms of a disease, etc. More generally, the external data may comprise any data relevant to determine traffic flow information in the area.

According to an exemplary embodiment, the processing means is configured to receive the external data from any one or more of the following external sources: GIS (Geographic Information Systems, such as Google Maps™), local authorities of a city, mobiles devices of users of a navigation system (e.g. TomTom® or Waze® GPS navigation systems), a database of a navigation system, toll stations, mobile communications (e.g. data based on cell phone localization), RDS-TMC (Radio Data System-Traffic Message Channel) traffic messages, a database containing information about traffic events, in particular mass events, etc. The external data may be freely available from said external sources, or on the contrary a subscription fee and/or access credentials may be required, depending on the open-source nature or not of said external sources. For some external sources, users may be requested to download an application on their mobile devices.

According to an exemplary embodiment, detecting objects in the area based on the sensed sequence of signals over time may comprise determining which portions of the signals belong to an object in the sensed sequence of signals. In exemplary embodiments wherein the sensing means comprises an image capturing means, detecting objects in the area based on the captured sequence of images over time may comprise determining which pixels belong to an object in the captured sequence of images. The processing means may assign a class to the detected objects. Classes may correspond to classes for static objects, such as static infrastructure elements (e.g., roads, luminaires, traffic lights, buildings, street furniture, etc.), or for moving objects, such as road users (e.g., cars, busses, trams, bicycles, pedestrians, UAVs, etc.) or non-human animals. In addition, the processing means may determine a minimum bounding box around moving objects in the captured sequence of images, wherein a bounding box is a polygonal, for example rectangular, border that encloses an object in a 2D image, or a polyhedral, for example a parallelepiped, border that encloses an object in a 3D image.

According to a preferred embodiment, the processing means is configured to detect one or more infrastructure elements in the area based on the sensed sequence of signals over time, and to determine the one or more infrastructure elements in the sensed sequence of signals over time optionally using the external data. By “infrastructure elements”, it is meant in the context of the invention static infrastructure elements in the area such as roads, bikeways, pedestrian pathways, railway tracks, waterways, airways, at least one lane of a road surface or a pedestrian surface, luminaires, traffic lights, buildings, street furniture, parking places such as car parks, etc.

It should be clear to the skilled person that the processing means may alternatively or additionally be configured to determine the one or more infrastructure elements in the sensed sequence of signals over time using signal processing techniques applied to the sensed sequence of signals over time.

According to a preferred embodiment, the processing means is configured to detect moving objects on the traffic surface based on the sensed sequence of signals over time, and to determine the one or more infrastructures elements, e.g. at least one lane of the traffic surface, in the sensed sequence of signals over time using information associated with the detected moving objects on the traffic surface.

Using information associated with the detected moving objects on the traffic surface, for example apparent trajectories of the detected objects, may improve the determination of e.g. the at least one lane of the traffic surface. In fact, the determination of the at least one lane may be improved by comparing the apparent trajectories of moving objects traveling in the area, since sufficiently similar trajectories are expected to belong to the same lane. It is noted that the above statement may apply to vehicles on a road surface and/or to persons on a pedestrian surface.

According to a preferred embodiment, the processing means is configured to detect one or more persons on the pedestrian area based on the sensed sequence of signals over time, and to determine traffic flow information related to said one or more persons in the sensed sequence of signals over time optionally using the external data.

It should be clear to the skilled person that the processing means may alternatively or additionally be configured to determine the traffic flow information related to said one or more persons in the sensed sequence of signals over time using signal processing techniques applied to the sensed sequence of signals over time.

According to a preferred embodiment, the processing means is configured to receive a position and sensing direction of the sensing means, and to determine the one or more infrastructure elements in the sensed sequence of signals over time using the position and sensing direction.

According to a preferred embodiment, the processing means is configured to receive a position and sensing direction of the sensing means, and to determine the at least one lane of the road surface, in the sensed sequence of signals over time using the position and sensing direction. In exemplary embodiments wherein the sensing means comprises an image capturing means, the sensing direction may correspond to a viewing direction of the image capturing means.

According to a preferred embodiment, the processing means is configured to receive a position and sensing direction of the sensing means, and to determine the traffic flow information related to said one or more persons in the sensed sequence of signals over time using the position and sensing direction. In exemplary embodiments wherein the sensing means comprises an image capturing means, the sensing direction may correspond to a viewing direction of the image capturing means.

In other words, the determination of traffic flow information related to said objects in the sensed sequence of signals over time optionally using the external data may comprise the determination of the one or more infrastructure elements as defined above in the sensed sequence of signals over time. The approach of using the position and sensing direction may be combined with the optional external data so as to allow for improvement in the accuracy of the determination of the one or more infrastructure elements. Indeed, the accuracy may depend on an angle and a perspective of the sensing means. Thus, receiving the position and sensing direction of the sensing means allows for improvement in the accuracy of the determination of the traffic flow information in the sequence of signals over time for a broader range of angles and perspectives of the sensing means.

It should be clear to the skilled person that the approach of using the position and sensing direction may alternatively or additionally be combined with signal processing techniques applied to the sensed sequence of signals over time so as to allow for improvement in the accuracy of the determination of the one or more infrastructure elements.

According to an embodiment, the processing means may receive the position and sensing direction of the sensing means directly from the sensing means. The sensing means may comprise a localization means such as a GPS receiver, and an orientation sensing means such as a gyroscope or an accelerometer.

According to an alternative embodiment, the processing means may receive the position and sensing direction of the sensing means from a remote device, such as a remote server or a mobile device, which contains information pertaining to the location (e.g. GPS localization) and/or settings (e.g. tilting angle with respect to the ground surface or horizon, an azimuthal angle) and/or configuration and/or type (e.g. a camera) of the sensing means.

According to an exemplary embodiment, the processing means is configured to determine a type of each of the determined at least one lane optionally using the external data. This may apply to vehicles on a road surface and/or to persons on a pedestrian surface. In other words, the at least one lane may belong to a road surface or to a pedestrian surface.

It should be clear to the skilled person that the processing means may alternatively or additionally be configured to determine the type of each of the determined at least one lane using signal processing techniques applied to the sensed sequence of signals over time.

In this way, the accuracy of the determination of the at least one lane may be further improved. As mentioned above, the processing means may be configured to determine a travel direction and/or one or more traffic surface markings (e.g. an arrow road marking, a bus-only lane, a one-way lane, etc.) using the external data.

According to a preferred embodiment, the processing means is configured to associate each of the detected vehicles with a corresponding lane of the determined at least one lane. According to another preferred embodiment, the processing means is configured to associate each of the detected persons with a corresponding lane of the determined at least one lane.

This preferred embodiment may be particularly advantageous in order to determine traffic flow information with respect to each lane of the determined at least one lane. In exemplary embodiments wherein the sensing means comprises an image capturing means and the processing means may determine a minimum bounding box around moving objects in the captured sequence of images, the detected objects may be associated with a corresponding lane if the center of the minimum bounding box of the detected objects belongs to the corresponding lane.

According to an exemplary embodiment, the processing means is configured to classify portions of the signals belonging to each of the detected moving objects in the sensed sequence of signals over time into respective lanes of the determined at least one lane. In exemplary embodiments wherein the sensing means comprises an image capturing means, the processing means may be configured to classify pixels belonging to each of the detected moving objects in the captured sequence of images over time into respective lanes of the determined at least one lane.

This exemplary embodiment may be particularly advantageous in order to determine if a moving object is moving within a lane or is crossing the boundary between two adjacent lanes.

According to a preferred embodiment wherein the processing means is further configured to receive a position and sensing direction of the sensing means, the external data comprises a map of the area, and the processing means is configured to determine the one or more infrastructure elements by adjusting (i.e., fitting) the map to the sensed sequence of signals over time using the position and sensing direction of the sensing means.

According to a preferred embodiment wherein the processing means is further configured to receive a position and sensing direction of the sensing means, the external data may comprise a map comprising the at least one lane of the road surface, and the processing means is configured to determine the at least one lane by adjusting (i.e., fitting) the map to the sensed sequence of signals over time using the position and sensing direction of the sensing means.

According to a preferred embodiment wherein the processing means is further configured to receive a position and sensing direction of the sensing means, the external data comprises a map of the pedestrian surface, and the processing means is configured to determine the one or more persons by adjusting the map to the sensed sequence of signals over time using the position and sensing direction of the sensing means.

In exemplary embodiments wherein the sensing means comprises an image capturing means, the processing means may be further configured to receive a position and viewing direction of the image capturing means, the external data may comprise a map comprising the one or more infrastructure elements, and the processing means may be configured to determine the one or more infrastructure elements by adjusting (i.e., fitting) the map to the captured sequence of images over time using the position and viewing direction of the image capturing means. In said embodiments, the map may contain relative positions and dimensions of various static infrastructure elements, such as lanes or buildings or street furniture. As mentioned above, the map may also contain a scale indicated thereon, that may be used by the processing means in order to estimate dimensions or distances between objects on the map. The adjustment (or fit, or mapping) of the map to the captured sequence of images may involve symmetry operations such as translations, rotations, homotheties (i.e., resizing), and the like, e.g. using the scale indicated on the map.

In this way, the processing means may recognize said static infrastructure elements on the sensed sequence of signals over time and determine which portions of the signals, e.g. which pixels, belong to those static infrastructure elements. The processing means may in addition recognize moving objects such as vehicles or persons on the sensed sequence of signals over time and determine which portions of the signals, e.g. which pixels, belong to those moving objects. The position and sensing direction of the sensing means may be particularly advantageous in order to accurately perform the adjustment (or fit, or mapping) for a broader range of angles and perspectives of the sensing means.

According to a preferred embodiment, the processing means is configured to determine a movement direction of the detected vehicles within the determined at least one lane. According to another preferred embodiment, the processing means is configured to determine a movement direction of the detected persons on the pedestrian surface, e.g. within a determined at least one lane thereof.

The above embodiment may be useful to detect the main direction of traffic on a given lane. Thus, the above embodiment may be useful to detect the presence of a ghost driver (i.e., a driver driving on the wrong side/direction of the road) and yield an alert and/or identify a license plate of the ghost driver if such a ghost driver is detected. The above embodiment may also be useful to detect that a vehicle is moving in the direction of a zebra crossing or driving near a sidewalk and yield an alert if pedestrians and/or non-human animals are about to cross.

According to a further embodiment, the processing means is configured to determine if a lane of the determined at least one lane of the road surface has a side turn optionally using the external data, and if yes, determine a first virtual barrier before the side turn and a second virtual barrier after the side turn.

It should be clear to the skilled person that the processing means may alternatively or additionally be configured to determine if the lane of the determined at least one lane of the road surface has a side turn using signal processing techniques applied to the sensed sequence of signals over time.

In this way, the processing means may determine the number of vehicles turning left or right on said lane by subtracting the number of vehicles crossing the second virtual barrier from the number of vehicles crossing the first virtual barrier. The external data may in this case comprise one or more road surface markings comprising a turn-left or turn-right arrow road marking. Said arrow road markings may be visible in a map comprising the at least one lane. In exemplary embodiments wherein the sensing means comprises an image capturing means, the processing means may recognize said arrow road markings by applying image processing techniques to the map.

According to an exemplary embodiment, a virtual barrier may correspond to a virtual line segment in the sensed sequence of signals over time that is bounded by a first point in a first boundary of a lane and by a second point in a second boundary of a lane, the second boundary being the same or different from the first boundary. In some embodiments, a virtual barrier may be a virtual line segment that is perpendicular to a first boundary of a lane and to a second boundary of said lane that is different from the first boundary, in order to detect vehicles travelling on the lane. In some other embodiments, a virtual barrier may correspond to a virtual line segment bounded by a first point and by a second point, the second point being different from the first point, wherein the first and the second points are part of the same boundary of a lane, in order to detect a vehicle changing lanes from a first lane to a second lane of a road surface comprising two or more lanes.

According to a preferred embodiment wherein the processing means is configured to detect vehicles on the road surface based on the sensed sequence of signals over time and determine the at least one lane of the road surface in the sensed sequence of signals over time, optionally using the external data, the processing means may be configured to determine at least one first virtual barrier within the determined at least one lane, determine at least one second virtual barrier within the determined at least one lane, measure a time difference between a first time at which a detected vehicle passes one of the at least one first virtual barrier and a second time at which the detected vehicle passes one of the at least one second virtual barrier, and determine an average speed of the detected vehicle using the external data and the time difference.

In the above embodiment, a virtual barrier as defined above may be determined for each lane of the determined at least one lane. In other words, each of the determined at least one lane may be assigned with a corresponding first virtual barrier of the at least one first virtual barrier, and with a corresponding second virtual barrier of the at least one second virtual barrier. Each virtual barrier may be labeled in the at least one first and at least one second virtual barrier, so as to discriminate between the virtual barriers.

In an example, detecting a time at which a vehicle passes a virtual barrier may correspond to detecting a time at which the center of a minimum bounding box of the detected vehicle crosses the corresponding virtual barrier. In an exemplary embodiment wherein the detected vehicle crosses one of the at least one first virtual barrier corresponding to a first lane at a first time, and one of the at least one second virtual barrier corresponding to a second lane at a second later time, the second lane being different from the first lane, the processing means may determine that the detected vehicle has changed lanes between the first time and the second time.

According to an exemplary embodiment, the processing means is configured to determine a calibration function using a set of known average speeds from the external data and a set of measured time differences corresponding to the set of known average speeds, and determine the average speed of the detected vehicle using the calibration function. For example, the set of known average speeds may be obtained from mobile devices of users of a GPS navigation system, such as the above-mentioned TomTom® or Waze® GPS navigation systems, or from any speed sensing means, such as an inductive traffic loop or a temporary radar.

In this way, in exemplary embodiments wherein the sensing means comprises an image capturing means, the system allows to avoid the use of expensive stereoscopic image capturing means in order to determine the average speed of a vehicle. Indeed, due to the stereoscopic nature of such an image capturing means, depth information about a captured stereo image is available, and thus a distance can be estimated between two points on the captured stereo image based on the depth information. Hence, based on a stereoscopic image capturing means, an average speed of a vehicle can be determined by dividing the estimated distance by the time difference measured between the two points.

By contrast, the system described above allows for the use of a simpler, and thus cheaper, image capturing means such as a regular camera capturing 2D images, wherein no depth information is required, i.e., wherein no estimation of a distance between two points on a captured image is needed. Indeed, in order to determine the average speed of a detected vehicle, the system only makes use of measured time differences and external data. For example, the system may use a calibration function determined from a plot of several known average speeds obtained from the external data as a function of the measured time differences. Said calibration function may be determined by e.g. fitting techniques such as a least-square fit or the like.

As explained above, a time difference is measured between a first time at which a detected vehicle passes one of the at least one first virtual barrier and a second time at which the detected vehicle passes one of the at least one second virtual barrier. Hence, once the calibration function is known, the system is able, by simply measuring a time difference for a detected vehicle, to determine the average speed of said detected vehicle by simply selecting the value given by the calibration function of the average speed corresponding to the measured time difference.

According to an exemplary embodiment, the processing means is configured to detect vehicles on a road surface based on the sensed sequence of signals over time, determine at least two lanes of the road surface in the sensed sequence of signals over time, optionally using the external data, determine within each of the determined at least two lanes a first virtual barrier and a second virtual barrier, measure for each of the determined at least two lanes a respective time difference between a first time at which a respective detected vehicle passes the first virtual barrier and a second time at which the respective detected vehicle passes the second virtual barrier, and determine a respective average speed of each of the respective detected vehicles on each of the determined at least two lanes using the external data and the at least two respective time differences.

The first virtual barrier may be the same for each of the determined at least two lanes. Likewise, the second virtual barrier may be the same for each of the determined at least two lanes. In other words, the determined at least two lanes may, but do not need to, share a first virtual barrier and/or a second virtual barrier.

According to an exemplary embodiment, the processing means is configured to acquire a known average speed from the external data over the determined at least two lanes, average the at least two respective time differences to obtain an average time difference over the determined at least two lanes, and determine the respective average speed of each of the respective detected vehicles on each of the determined at least two lanes by comparing the average time difference with the known average speed.

According to an exemplary embodiment, the processing means is configured to calibrate the average time difference with the known average speed to determine a calibrated distance between the first virtual barrier and the second virtual barrier, and determine the respective average speed of each of the respective detected vehicles on each of the determined at least two lanes by dividing the calibrated distance by the respective time difference. Said calibrated distance may be determined by e.g. fitting techniques such as a least-square fit or the like.

In this way, a calibration of each of the determined at least two lanes may be performed using the external data, e.g. the known average speed over the determined at least two lanes, and the at least two measured respective time differences, so as to determine the respective average speed of each of the respective detected vehicles on each of the determined at least two lanes.

According to a preferred embodiment wherein the processing means is configured to detect vehicles on the road surface based on the sensed sequence of signals over time and determine the at least one lane of the road surface in the sensed sequence of signals over time, optionally using the external data, the processing means may be configured to determine at least one virtual barrier within the determined at least one lane, and determine when a detected vehicle passes the at least one virtual barrier.

Detection may be done each time a vehicle's trajectory intersects with any one of the at least one virtual barrier. In an example, a vehicle's trajectory may correspond to the trajectory of the center of the minimum bounding box of the vehicle.

According to an exemplary embodiment, the processing means is configured to determine at least one virtual barrier within the traffic surface, and to count a number of detected moving objects crossing the at least one virtual barrier. As explained above, the traffic surface may correspond to e.g. a road surface or a pedestrian surface. Accordingly, the above-mentioned definition of a virtual barrier in the context of the invention may apply to a road surface, as explained above, or to a pedestrian surface. In other words, the at least one virtual barrier may be used to count a number of detected vehicles on a road surface, or to count a number of detected persons on a pedestrian surface.

According to an exemplary embodiment, the processing means is configured to count a number of detected moving objects crossing the at least one virtual barrier. A counter may be incremented by one each time a detected moving object, e.g. a vehicle or a person, crosses any one of the at least one virtual barrier. If the moving objects intended to be counted are vehicles travelling on at least one lane of a road surface, there may be one virtual barrier for each determined lane, such that the counting is performed for each lane of the determined at least one lane. If the moving objects intended to be counted are persons travelling on a pedestrian surface, there may be one virtual barrier for the entire pedestrian surface, such that the counting is performed for the entire pedestrian surface. If the pedestrian surface comprises at least one lane, there may be one virtual barrier for each determined lane, such that the counting is performed for each lane of the determined at least one lane.

According to a preferred embodiment, the processing means is configured to determine a set of virtual barriers defining together an enclosed area within the traffic surface, and to determine a difference between moving objects entering the enclosed area and moving objects exiting said enclosed area. As explained above, the enclosed area may correspond to e.g. an enclosed area within a road surface or within a pedestrian surface. Accordingly, the processing means may be configured to determine a difference between vehicles entering the enclosed area of the road surface and vehicles exiting said enclosed area, or to determine a difference between persons entering the enclosed area of the pedestrian surface and persons exiting said enclosed area.

According to a preferred embodiment wherein the processing means is configured to detect vehicles on the road surface based on the sensed sequence of signals over time and determine the at least one lane of the road surface in the sensed sequence of signals over time, optionally using the external data, the processing means may be configured to determine a set of virtual barriers within the determined at least one lane defining together an enclosed area within the road surface, and determine a difference between vehicles entering the enclosed area and vehicles exiting said enclosed area.

According to an exemplary embodiment, the enclosed area is defined in relation to the determined set of virtual barriers. Thus, the enclosed area may have a polygonal shape, wherein each side of the polygon corresponds to one or more virtual barriers of the determined set of virtual barriers. In an example, if different virtual barriers are aligned, e.g., each virtual barrier is determined for each of adjacent lanes of a plurality of determined lanes, the aligned different virtual barriers form together one side of the polygon. In another example, e.g., if a single virtual barrier is determined for adjacent lanes of a plurality of determined lanes, the single virtual barrier forms one side of the polygon. As explained above, the plurality of lanes may belong to a road surface or to a pedestrian surface.

The enclosed area may be defined so as to determine a traffic difference within a road surface, within a pedestrian surface, or within an intersection. This embodiment may be particularly advantageous in order to detect long-lasting traffic differences and/or to detect presence or absence of moving objects, e.g. vehicles or persons, in the enclosed area. For example, it may be used to detect specific traffic situations such as traffic jams, wherein traffic differences between moving objects, e.g. vehicles or persons, entering the enclosed area and moving objects, e.g. vehicles or persons, exiting said enclosed area are expected to last longer than other situations wherein the traffic is fluid. It may also be used to ensure there are no more moving objects, e.g. vehicles or persons, in a lane whose direction is reversible before reversing the direction of circulation. As mentioned above, the enclosed area may also be defined so as to determine a traffic difference within a pedestrian area. This embodiment may be particularly advantageous in order to determine how crowded an area is or to detect gatherings of people (e.g. undeclared protests). It may also be used to limit the access to an area in which a maximum number of people is allowed.

According to an exemplary embodiment, the processing means is configured to assign a +1 value to moving objects entering the enclosed area, assign a −1 value to moving objects exiting the enclosed area, and determine the difference by summing all values assigned to said moving objects.

According to an exemplary embodiment, the processing means is configured to assign a +1 value to vehicles entering the enclosed area, assign a −1 value to vehicles exiting the enclosed area, and determine the difference by summing all values assigned to said vehicles. The processing means may determine one or more differences each corresponding to different classes of road users.

According to an exemplary embodiment, the processing means is configured to assign a +1 value to persons entering the enclosed area, assign a −1 value to persons exiting the enclosed area, and determine the difference by summing all values assigned to said persons.

According to a preferred embodiment, the processing means is configured to detect a stationary vehicle on the road surface based on the sensed sequence of signals over time, detect persons in a portion of the area that surrounds the stationary vehicle based on the sensed sequence of signals over time, and determine an amount of detected persons in the sensed sequence of signals over time that enter or exit the stationary vehicle. Optionally, the processing means may be configured to receive a position and sensing direction of the sensing means.

For example, the processing means may detect a bus stopping at a bus stop, detect persons at the bus stop and determine the number of persons that enter or exit the bus. Therefore, the system may not only determine traffic flow information related to objects such as vehicles on a road surface, but may also determine traffic flow information related to objects such as pedestrians or public transport users on a pedestrian surface such as a sidewalk or a zebra crossing of the road surface. In this way, traffic flow information about the entire area comprising the traffic surface may be determined.

According to a preferred embodiment, the processing means is configured to detect persons in a portion of the area that surrounds the road surface based on the sensed sequence of signals over time, and determine an amount of detected persons in the sensed sequence of signals over time.

For example, the processing means may detect persons in a pathway such as a sidewalk or on a zebra crossing of the road surface, and determine the amount of detected persons in the sidewalk to estimate pedestrian traffic in the area. Determining the pedestrian traffic over time in the area may be advantageous to ensure appropriate urban planning, in order to avoid accidents between vehicles and pedestrian in areas known to exhibit a dense motorized traffic and at the same time a dense pedestrian traffic.

According to a preferred embodiment, the processing means is configured to detect persons on the pedestrian surface based on the sensed sequence of signals over time, and to determine an amount of detected persons in the sensed sequence of signals over time.

According to a second aspect of the invention, there is provided one or more luminaires comprising the system for determination of traffic flow information in an area comprising a traffic surface, such as a road surface or a pedestrian surface, as described in the above-mentioned embodiments of the first aspect of the invention.

According to a third aspect of the invention, there is provided a network of luminaires, said network comprising one or more luminaires according to the second aspect of the invention.

Luminaires, especially outdoor luminaires, are present worldwide in nearly every city or at the countryside. Smart luminaires able to work in networks are already present in densely populated areas, such as streets, roads, paths, parks, campuses, train stations, airports, harbors, beaches, etc., of cities around the world, from small towns to metropoles. Hence, a network of such luminaires is capable of automatically exchanging information between the luminaires and/or with a remote entity. Such a network is also capable of at least partially autonomously operating to propagate traffic flow information in an area comprising a traffic surface, such as a road surface or a pedestrian surface, that has been determined by one or more luminaires comprising the system according to the first aspect of the invention.

In this way, the traffic flow information may reach a remote entity, such as a local or a global road authority, so that the network can send signals pertaining to (real-time) monitoring of the traffic in said area. If needed, warning signals can be sent in case of a dangerous or potentially dangerous traffic situation. The network of such luminaires may also be used to warn users, in particular road users or pedestrians, of other areas, such as neighboring areas, that a particular traffic situation such as an accident or a traffic jam occurs in the area. In order to do so, at least one luminaire of the network should be provided with such a system. However, it is not required that all luminaires of the network be provided with such a system, although efficiency and accuracy of the traffic info determination may be increased.

Light outputted by one or more luminaires of the network may also be dynamically adjusted according to the determined traffic flow information of the area. For example, one or more luminaires in an area wherein the determined traffic flow is low may be dimmed or switched off in order to reduce the energy consumption of the one or more luminaires. In a situation where electricity is more difficult to access, such as in the case of high demand on the electricity grid or electricity prices higher than a certain threshold, priorities may be assigned to certain luminaires of the network based on the determined traffic flow information in the area in which these luminaires are located. For example, a lower priority may be assigned to luminaires in a less frequented area, so that these luminaires may be dimmed or switched off first in the situation where electricity is more difficult to access. Exchange of traffic flow information between two or more luminaires may occur in the network.

According to a fourth aspect of the invention, there is provided a method for determination of traffic flow information in an area comprising a traffic surface, such as a road surface or a pedestrian surface. The method comprises capturing a sequence of signals over time related to the area, receiving the sensed sequence of signals over time and optionally external data related to the area, detecting moving objects in the area based on the sensed sequence of signals over time, and determining traffic flow information related to said moving objects in the sensed sequence of signals over time optionally using the external data.

The skilled person will understand that the hereinabove described technical considerations and advantages for the system embodiments also apply to the above-described corresponding method embodiments, mutatis mutandis.

### BRIEF DESCRIPTION OF THE FIGURES

This and other aspects of the present invention will now be described in more detail, with reference to the appended drawings showing a currently preferred embodiment of the invention. Like numbers refer to like features throughout the drawings.

FIGS. 1A-1B illustrate schematically an exemplary embodiment of a system for determination of traffic flow information in an area comprising a road surface according to an exemplary embodiment;

FIGS. 2A-2E illustrate schematically exemplary embodiments of determining an average speed of a vehicle using external data according to an exemplary embodiment;

FIGS. 3A-3B illustrate schematically exemplary embodiments of a system for determination of a set of virtual barriers defining an enclosed area within a road surface (FIG. 3A) or within a cross-road intersection (FIG. 3B) according to an exemplary embodiment;

FIGS. 4A-4B illustrate schematically exemplary embodiments of a system for counting a number of vehicles driving through an enclosed area within a road surface (FIG. 4A) or within a cross-road intersection (FIG. 4B) according to an exemplary embodiment;

FIGS. 5A-5B illustrate schematically exemplary embodiments of a system for determination of an amount of detected persons that enter or exit a stationary vehicle according to an exemplary embodiment; and

FIGS. 6A-6C illustrate schematically exemplary embodiments of a system according to an exemplary embodiment which is provided on a luminaire.

### DESCRIPTION OF THE EMBODIMENTS

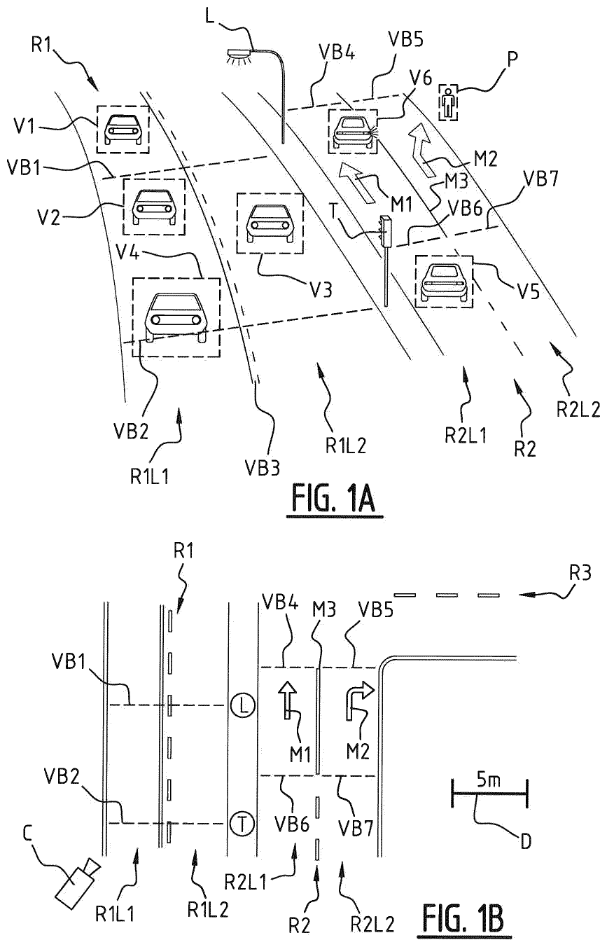

FIGS. 1A-1B illustrate schematically an exemplary embodiment of a system for determination of traffic flow information in an area comprising a road surface according to an exemplary embodiment.

The system comprises a sensing means C and a processing means (not shown). The sensing means C is configured to sense a sequence of signals over time related to the area, said sequence of signals over time comprising signals of at least one lane of the road surface. The sensing means C of FIGS. 1A-1B may comprise any one of the following: an image capturing means configured to capture a sequence of images, a LIDAR configured to capture a sequence of point clouds, a radar, a receiving means with an antenna configured to capture a sequence of signals, in particular a sequence of short-range signals, such as Bluetooth signals, a sound capturing means, or a combination thereof. The sensing means C may be configured to sense signals of the sequence of signals over time at consecutive time intervals, preferably at least two signals per second, more preferably at least 10 signals per second. In exemplary embodiments, the sensing means C may comprise an image sensing means, e.g. a camera, such as a visible light camera, configured to capture a sequence of images related to the area at consecutive time intervals, preferably at least two frames per second, more preferably at least 10 frames per second. The processing means may be included in the sensing means C, may be located in a position adjacent to that of the sensing means C, or may be located at a location which is remote from that of the sensing means C.

Referring to FIG. 1A, the sensing means C may sense a sequence of signals over time related to an area comprising a first road surface R1 and a second road surface R2. The first road surface R1 may comprise a first lane R1L1 and a second lane R1L2, and the second road surface R2 may comprise a first lane R2L1 and a second lane R2L2. In exemplary embodiments wherein the sensing means C comprises an image capturing means, the sequence of images may comprise images of at least one lane R1L1, R1L2 of the first road surface R1 and/or of at least one lane R2L1, R2L2 of the second road surface R2. The processing means may comprise an image processing means that may detect or recognize objects or features present in the area comprising the road surface e.g. by applying image processing techniques to the captured sequence of images. The processing means may assign a class to the detected objects. Classes may correspond to classes for static objects, such as static infrastructure elements (e.g., roads, luminaires, traffic lights, buildings, street furniture, etc.), or for moving objects, such as road users (e.g., cars, busses, trains, trams, bicycles, pedestrians, boats, etc.). In addition, in exemplary embodiments wherein the sensing means C comprises an image capturing means, the processing means may determine a minimum bounding box around moving objects in the captured sequence of image, wherein a bounding box is a polygonal, for example rectangular, border that encloses an object in a 2D image as illustrated in FIG. 1A, or a polyhedral, for example a parallelepiped, border that encloses an object in a 3D image.

The processing means is configured to receive the sensed sequence of signals over time and optionally external data related to the area, such as a map comprising the area, in particular the road surface (e.g. including a scale indicated on the map, that may be used to estimate dimensions or distances) and/or a layout of the road surface (e.g. crossroads intersection, pedestrian crossing, etc.) and/or information pertaining to the at least one lane of the road surface (e.g. number of lanes, type of a lane such as lane restricted to busses and/or bikes and/or electric cars, etc.), a geographic location of the area (name of district, name of city, name of region, name of country, etc.), a type of the area (e.g., urban area, suburban area, countryside area, etc.), a geographic location of street furniture (e.g. benches, streetlamps, traffic lights, bus or tram stops, taxi stands, etc.) in the area, an average speed of vehicles in one or more of the at least one lane of the road surface, real-time traffic, real-time information pertaining to traffic lights (e.g. traffic light color, time before switching to another color, etc.), information pertaining to traffic laws in the area (e.g., driving on the left in the UK and on the right in the EU or US, maximum speed limits on the road surface R1 and the road surface R2), information pertaining to a type of landscape in the area (type of buildings in the surroundings of the road surface such as schools, hospitals, residential area, shopping area), weather data (e.g. snow, rain, etc.), road surface condition data (wet, ice, etc.), a time schedule of objects passing in the area such as a time schedule of public transportation, etc. More generally, the external data may comprise any data relevant to determine traffic flow information in the area.

The processing means may be configured to receive the external data from any one or more of the following external sources: Geographic Information Systems, GIS, local authorities of a city, mobile devices of users of a navigation system, a database of a navigation system, toll stations, mobile communications, Radio Data System-Traffic Message Channel, RDS-TMC, traffic messages, a database containing information about traffic events.

The processing means is further configured to detect objects in the area based on the sensed sequence of signals over time, and to determine traffic flow information related to said objects in the sensed sequence of signals over time optionally using the external data. As illustrated in FIG. 1A, the processing means may detect objects such as vehicles V1-V6 and a pedestrian P in the area based on the sensed sequence of signals over time, and may not only determine traffic flow information related to objects such as the vehicles V1-V6 on road surfaces R1-R2, but may also determine traffic flow information related to objects such as the pedestrian P in a sidewalk of the road surface R2. For example, the processing means may recognize a first road marking M1 (see FIGS. 1A-1B) instructing vehicles to drive forward on the first lane R2L1, and a second road marking M2 (see FIGS. 1A-1B) instructing vehicles to turn right on the second lane R2L2, e.g. by applying image processing techniques. The processing means may determine that the vehicle V6 is not following the instruction of the first road marking M1 and is crossing a solid line marking M3 between the first lane R2L1 and the second lane R2L2, which are not allowed by traffic laws in the area.

Referring to FIGS. 1A-1B, the processing means may be configured to detect vehicles V1-V6 on the road surface R based on the sensed sequence of signals over time, and determine the at least one lane R1L1-R2L2 of the road surface R in the sensed sequence of signals over time, optionally using the external data. Preferably, the processing means may be further configured to receive a position and sensing direction of the sensing means C, and determine the at least one lane R1L1-R2L2 of the road surface R in the sensed sequence of signals over time further using the position and sensing direction. In exemplary embodiments wherein the sensing means C comprises an image capturing means, the sensing direction may correspond to a viewing direction of the image capturing means. In an embodiment, the processing means may receive the position and sensing direction of the sensing means C directly from the sensing means C. The sensing means C may comprise a localization means such as a GPS receiver, and an orientation sensing means such as a gyroscope or an accelerometer. In an alternative embodiment, the processing means may receive the position and sensing direction of the sensing means C from a remote device, such as a remote server or a mobile device, which contains information pertaining to the location (e.g. GPS localization) and/or settings (e.g. tilting angle with respect to the ground surface or horizon, an azimuthal angle) and/or configuration and/or type (e.g. a camera) of the sensing means C.

The external data may comprise a map comprising the area (see FIG. 1B), and in particular a map comprising the first road surface R1 and the second road surface R2. The map may contain relative positions and dimensions of various static infrastructure elements, such as a luminaire L and a traffic light T (see FIG. 1B). The map may also contain a scale D (see FIG. 1B). The processing means may receive the map of the area comprising the various static infrastructure elements, recognize those elements on the sensed sequence of signals over time and determine which portions of the signals belong to those elements. The position and sensing direction of the sensing means C may be used to perform this fitting accurately. In exemplary embodiments wherein the sensing means C comprises an image capturing means, the processing means may receive the map of the area comprising the various static infrastructure elements, recognize those elements on the captured sequence of images over time and determine which pixels belong to those elements. The position and viewing direction of the image capturing means may be used to perform this fitting accurately. The processing means may detect other static infrastructures elements not present in the received map of the area. The processing means may also detect moving objects, such as vehicles V and pedestrians P, and determine a minimum bounding box around those objects, wherein the bounding box, in this example is rectangular and encloses an object in a 2D image.

Referring to FIGS. 1A-1B, the processing means may be configured to determine a type of each of the determined at least one lane optionally using the external data. For example, the road surface R2 may comprise a first lane R2L1 and a second lane R2L2. Each lane may have a type comprising: a travel direction and/or one or more road surface markings (e.g. an arrow road marking as illustrated in FIGS. 1A-1B, a bus-only lane, a one-way lane, etc.). The processing means may be configured to associate each of the detected vehicles V5, V6 with a corresponding lane (e.g., the lane R2L1 in the case illustrated in FIG. 1A) of the determined first and second lanes R2L1, R2L2.

Further, the processing means may be configured to classify portions of the signals belonging to each of the detected vehicles V5, V6 in the sensed sequence of signals over time into respective lanes of the determined first and second lanes R2L1, R2L2. In exemplary embodiments wherein the sensing means C comprises an image capturing means, the processing means may be configured to classify pixels belonging to each of the detected vehicles V5, V6 in the captured sequence of images over time into respective lanes of the determined first and second lanes R2L1, R2L2. In the embodiment of FIGS. 1A-1B, all pixels belonging to vehicle V5 are associated with lane R2L1, whereas some of the pixels belonging to vehicle V6 are associated with lane R2L2, the remaining pixels being associated with lane R2L1. It is noted that the above disclosure also applies to the road surface R1 of FIGS. 1A-1B, which comprises vehicles V1-V4.

As illustrated in the embodiment of FIGS. 1A-1B, the processing means may be configured to detect vehicles V1-V6 on the road surface R1 or R2, respectively, based on the sensed sequence of signals over time, to determine at least one virtual barrier, for example, seven virtual barriers VB1-VB7, within the determined at least one lane R1L1-R2L2, and to determine when a detected vehicle V1-V6 passes the at least one virtual barrier VB1-VB7. A first virtual barrier VB1 may be a line segment perpendicular to a first boundary of the road surface R1 and a second boundary of the road surface R1 different from the first boundary to detect vehicles travelling within the road surface R1. The location of the virtual barriers may be determined by the processing means, e.g. using image processing techniques, or instructed to the processing means from information contained in the external data, e.g. from information containing one or more predefined points of reference.

In an example, the first virtual barrier VB1 may be set using a first point of reference, such as the luminaire L. A second virtual barrier VB2 may be set using a second point of reference, such as the traffic light T. The distance between the first virtual barrier VB1 and the second virtual barrier VB2 may be known, e.g. using the scale D contained in the map. A third virtual barrier VB3 may be set as the boundary between the first lane R1L1 and the second lane R1L2 of the road surface R1. If any one of vehicles V1, V2, or V4 crosses the third virtual barrier VB3, the processing means may yield an alert and/or identify a license plate of the vehicle not complying with traffic laws since changing lanes is not allowed for vehicles travelling in the first lane R1L1. Indeed, as illustrated in FIG. 1B the lane marking between the first lane R1L1 and the second lane R1L2 may be such that changing lanes may be allowed only for vehicles travelling in the second lane R1L2.

At least one first virtual barrier comprising a fourth virtual barrier VB4 and a fifth virtual barrier VB5 may be set using a third point of reference, such as an intersection between the road surface R2 and another road surface R3 (e.g., turning right; see FIG. 1B). The fourth virtual barrier VB4 may be a line segment perpendicular to a first boundary and a second boundary of the first lane R2L1, the second boundary being different from the first boundary. The fifth virtual barrier VB5 may be a line segment perpendicular to a first boundary and a second boundary of the second lane R2L2, the second boundary being different from the first boundary.

At least one second virtual barrier comprising a sixth virtual barrier VB6 and a seventh virtual barrier VB7 may be set using the at least one first virtual barrier as a reference, such that the at least one second virtual barrier is located a few meters, e.g. 6 meters, before the at least one first virtual barrier. The sixth virtual barrier VB6 may be a line segment perpendicular to a first boundary and a second boundary of the first lane R2L1, the second boundary being different from the first boundary. The seventh virtual barrier VB7 may be a line segment perpendicular to a first boundary and a second boundary of the second lane R2L2, the second boundary being different from the first boundary.

As can be seen in the embodiment of FIG. 1A, a vehicle V6 that has travelled in the first lane R2L1, has crossed the sixth virtual barrier VB6 and is changing lanes. The vehicle V6 is about to cross the fifth virtual barrier VB5, and the processing means may determine that the vehicle V6 has changed lanes, since the fifth virtual barrier VB5 corresponds to a lane different from that of the sixth virtual barrier VB6. The processing means may then yield an alert and/or identify a license plate of the vehicle V6 if changing lanes from the first lane R2L1 to the second lane R2L2 is not allowed or if the vehicle V6 has not signaled turning right during the time interval between a first time at which the vehicle V6 has crossed the sixth virtual barrier VB6 and a second time at which the vehicle V6 has crossed the fifth virtual barrier VB5. The license plate of other vehicles complying with traffic laws may not be identified to ensure anonymization of the determined traffic flow information.

In an exemplary embodiment, the optional external data may comprise information, preferably real-time information, pertaining to traffic lights, such as traffic light color or time before switching to another color. The processing means may be configured to use the determined traffic flow information to determine which traffic lights of the area may be switched to another color in order to fluidify the traffic on the area. For example, if more vehicles are waiting in front of a red traffic light on the second lane R2L2 than the first lane R2L1, the traffic lights may be dynamically adjusted to become green for vehicles turning right. Traffic lights may also be controlled separately for different traffic flows in order to avoid accidents between those traffic flows. For example, traffic lights may be controlled separately for right-turning drivers and cyclists going straight ahead by allowing the bicycle traffic flow to go straight ahead when the right-turning car traffic flow faces a red light, and allowing the right-turning car traffic flow to turn right when the bicycle traffic flow faces a red light. In that manner, accidents between right-turning drivers and cyclists going straight ahead may be avoided.

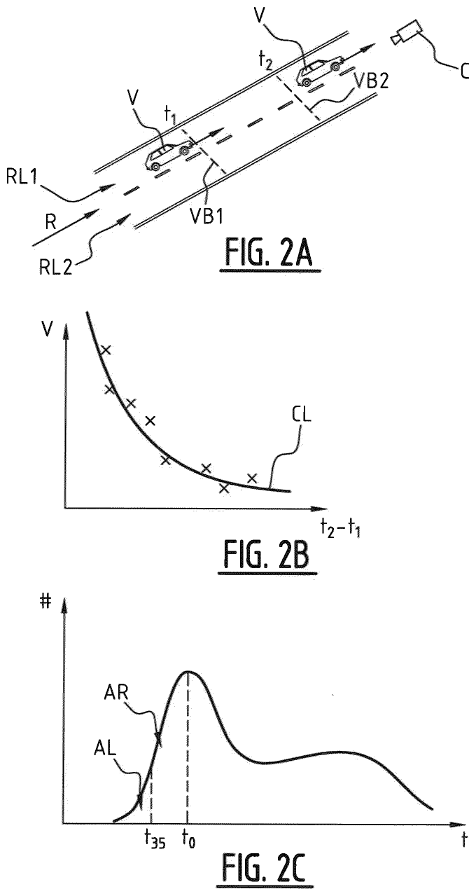

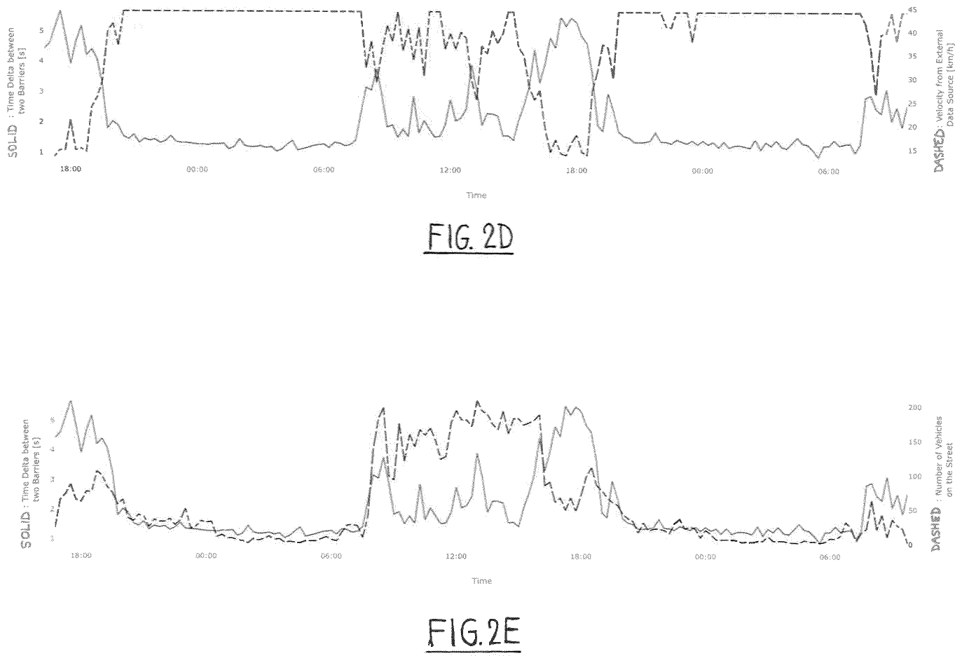

FIGS. 2A-2E illustrate schematically exemplary embodiments of determining an average speed of a vehicle using external data according to an exemplary embodiment.

Referring to FIGS. 2A-2E, the processing means may be configured to detect vehicles V on the road surface R based on the sensed sequence of signals over time, and determine the at least one lane RL1, RL2 of the road surface R in the sensed sequence of signals over time, optionally using the external data. Preferably, the processing means may be further configured to receive a position and sensing direction of the sensing means C, and determine the at least one lane RL1, RL2 of the road surface R in the sensed sequence of signals over time using the position and sensing direction.

As illustrated in the embodiment of FIG. 2A, the processing means may be configured to determine at least one first virtual barrier, for example at least one first virtual barrier comprising one virtual barrier VB1, within the determined at least one lane RL1-RL2, and to determine at least one second virtual barrier, for example at least one second virtual barrier comprising one virtual barrier VB2, within the determined at least one lane RL1-RL2. The processing means may be configured to measure a time difference between a first time t1 at which a detected vehicle V passes one of the at least one first virtual barrier, for example the virtual barrier VB1, and a second time t2 at which the detected vehicle V passes one of the at least one second virtual barrier, for example the virtual barrier VB2. The processing means may be further configured to determine an average speed of the detected vehicle V using the external data and the time difference t2−t1. For example, the processing means may determine an average speed of the detected vehicle V using a distance between the first virtual barrier VB1 and the second virtual barrier VB2 that may be known using a scale contained in a map, such as the map described above in connection with FIGS. 1A-1B, and the measured time difference t2−t1 by simply dividing the distance by the measured time difference t2−t1.

In exemplary embodiments wherein the sensing means C comprises a receiving means with an antenna, the processing means may determine an average speed of the detected vehicle V using a signal strength of the received sequence of short-range, e.g. Bluetooth, signals emitted from the detected vehicle V, for example from a mobile device inside the detected vehicle V. In other exemplary embodiments wherein the sensing means C comprises a LIDAR, the processing means may determine an average speed of the detected vehicle V using a distance between the first virtual barrier VB1 and the second virtual barrier VB2 that may be known using the sensed sequence of point clouds.

Alternatively or in addition, as illustrated in the embodiment of FIG. 2B, the processing means may be further configured to determine a calibration function CL using a set of known average speeds from the external data, for example from mobile devices of users of a GPS navigation system, such as TomTom® or Waze® GPS navigation systems, and a set of measured time differences t2−t1 corresponding to the set of known average speeds. For example, the processing means may determine a calibration function CL from a plot of several known average speeds obtained from the external data as a function of the measured time differences t2−t1. Said calibration function CL may be determined by e.g. fitting techniques such as a least-square fit or the like. The processing means may be configured to determine the average speed of the detected vehicle V using the calibration function CL. As explained above, referring to FIG. 2A, a time difference t2−t1 is measured between a first time t1 at which a detected vehicle V passes one of the at least one first virtual barrier, for example VB1, and a second time t2 at which the detected vehicle V passes one of the at least one second virtual barrier, for example VB2. Hence, once the calibration function CL is known, the system is able, by simply measuring a time difference t2−t1 for a detected vehicle V, to determine the average speed of said detected vehicle V by simply selecting the value given by the calibration function CL of the average speed corresponding to the measured time difference t2−t1.

As illustrated in FIG. 2D, a set of measured time differences t2−t1 (expressed in seconds; solid curve) for a number of detected vehicles V on the road surface R between the virtual barriers VB1 and VB2 of FIG. 2A is plotted as a function of time together with a set of known average speeds (expressed in km/h; dashed curve) from TomTom® used as the external data, the set of known average speeds corresponding to the set of measured time differences t2−t1. It should be clear to the skilled person that the external data may be obtained from other external sources than TomTom®, for example from mobile devices of users of Waze® GPS navigation system.

In FIG. 2D, the variable “Time” as x-axis corresponds to the time of the day, from day 1 at around 18:00 to day 3 at around 9:00. The set of measured time differences t2−t1 as left y-axis in FIG. 2D is obtained at a given time T by averaging the time differences measured for all the vehicles crossing the virtual barriers VB1 and VB2 during the last 15 minutes before said given time T, so as to obtain a smoother solid curve. The set of known average speeds as right y-axis in FIG. 2D is obtained at a given time T by a simple query to TomTom® to provide with traffic information at said given time T with respect to a selected geographic area given as an input to TomTom®. In the illustrated embodiment, said selected geographic area corresponds to the portion of the road surface R of FIG. 2A comprised between the virtual barriers VB1 and VB2.

As illustrated in FIG. 2D, an anti-correlation between the set of measured time differences t2−t1 and the set of known average speeds can be inferred from the plot of the two curves in FIG. 2D.

Indeed, at times T when the measured time difference t2−t1 is relatively low, the known average speed is relatively high. For example, during the night between day 1 and day 2, the measured time differences t2−t1 are comprised between 1s and 2s, whereas the curve of known average speeds reaches its highest values (saturation at a maximum speed of 44 km/h). This situation corresponds to a period where there are relatively few vehicles crossing the virtual barriers VB1 and VB2 and travelling at relatively high speeds. A similar situation occurs during the night between day 2 and day 3.

Vice versa, at times T when the measured time difference t2−t1 is relatively high, the known average speed is relatively low. For example, during the traffic peak hour in the late afternoon of day 2 (around 18:00), the measured time differences t2−t1 are comprised between 3s and 6s, whereas the curve of known average speeds reaches its lowest values (minimum speed of 14 km/h). This situation corresponds to a period where there are relatively many vehicles crossing the virtual barriers VB1 and VB2 and travelling at relatively low speeds. A similar situation occurs during the traffic peak hour in the early morning of day 2 (around 8:00).

The anti-correlation between the set of measured time differences t2−t1 and the set of known average speeds can be quantified from the plot of the two curves in FIG. 2D, in order to assess the reliability of the calibration line CL (see FIG. 2B) that can be obtained from the two curves illustrated in FIG. 2D. In the illustrated embodiment, said anti-correlation equals −0.95 (the minus sign corresponding to an anti-correlation), which shows good agreement between the two sets of data used to plot the two curves in FIG. 2D. Indeed, an anti-correlation between two ideal sets of such data should reach −1.0, as the average speed of a vehicle between two virtual barriers is inversely proportional to the time spent by the vehicle between the two virtual barriers.

As illustrated in FIG. 2E, the same set of measured time differences t2−t1 as in FIG. 2D (solid curve) is plotted as a function of time together with a set of counted numbers of detected vehicles V on the road surface R that have crossed one of the two virtual barriers VB1 and VB2 of FIG. 2A (dashed curve) from TomTom® used as the external data, the set of counted numbers of detected vehicles V corresponding to the set of measured time differences t2−t1.

In FIG. 2E, the variable “Time” as x-axis corresponds to the time of the day, from day 1 at around 18:00 to day 3 at around 9:00. The same values of “Time” are used in FIGS. 2D and 2E. The set of measured time differences t2−t1 as left y-axis in FIG. 2E corresponds to that of FIG. 2D. The set of counted numbers of detected vehicles V as right y-axis in FIG. 2E is obtained at a given time T by a simple count of the number of detected vehicles V that have crossed one of the two virtual barriers VB1 and VB2 at said time T. Thus, contrary to FIG. 2D, no external data is used for plotting the two curves of FIG. 2E.

As illustrated in FIG. 2E, correlations as well as anti-correlations between the set of measured time differences t2−t1 and the set of counted numbers of detected vehicles V can be inferred from the plot of the two curves in FIG. 2E.

Indeed, at times T when the measured time difference t2−t1 is relatively low, the counted number of detected vehicles V can be relatively low too. For example, during the night between day 1 and day 2, the measured time differences t2−t1 are comprised between 1s and 2s, whereas the curve of counted numbers of detected vehicles V reaches its lowest values (minimum count of 20 vehicles). This situation corresponds to a period where there are relatively few vehicles crossing one of the virtual barriers VB1 and VB2 and travelling at relatively high speeds (see FIG. 2D). A similar situation occurs during the night between day 2 and day 3. In other words, these situations correspond to a correlation between the measured time differences t2−t1 and the counted numbers of detected vehicles V.

Vice versa, at times T when the measured time difference t2−t1 is relatively high, the counted number of detected vehicles V can be relatively high too. For example, during the traffic peak hour in the early morning of day 2 (around 8:00), the measured time differences t2−t1 are comprised between 3s and 4s, whereas the curve of counted numbers of detected vehicles V reaches relatively high values (local maximum count of 200 vehicles). This situation corresponds to a period where there are relatively many vehicles crossing the virtual barriers VB1 and VB2 and travelling at relatively high speeds (see FIG. 2D), thus without creating a traffic jam. Indeed, the traffic at said traffic peak hour in the early morning seems to stay fluid, which is confirmed by the relatively high average speeds indicated in FIG. 2D for said traffic peak hour. In other words, this situation also corresponds to a correlation between the measured time differences t2−t1 and the counted numbers of detected vehicles V.

On the contrary, at times T when the measured time difference t2−t1 is relatively high, the counted number of detected vehicles V can be relatively low. For example, during the traffic peak hour in the late afternoon of day 2 (around 18:00), the measured time differences t2−t1 are comprised between 3s and 6s, whereas the curve of counted numbers of detected vehicles V reaches relatively low values (local minimum count of 50 vehicles). This situation corresponds to a period where there are relatively few vehicles crossing the virtual barriers VB1 and VB2 and travelling at relatively low speeds (see FIG. 2D), thus creating a traffic jam. Indeed, the traffic at said traffic peak hour in the early morning seems to increase, which is confirmed by the relatively low average speeds indicated in FIG. 2D for said traffic peak hour. In other words, contrary to the above situations, this situation corresponds to an anti-correlation between the measured time differences t2−t1 and the counted numbers of detected vehicles V.

The anti-correlation between the set of measured time differences t2−t1 and the set of counted numbers of detected vehicles V can be used to determine a saturation of traffic at a given time T on a portion of the road surface R, such as the portion illustrated in FIG. 2A between the two virtual barriers VB1 and VB2, i.e., to determine a traffic jam on said portion of the road surface R.

Alternatively or in addition to the embodiment of FIGS. 2B and 2D-2E, as illustrated in the embodiment of FIG. 2C, the processing means may determine a distribution of time spent by vehicles on a road surface, and may compare time spent by future vehicles travelling on the road surface to the determined distribution of time. By doing so, the processing means may determine if traffic is fluid on the road surface. For example, if vehicles V1-V4 illustrated in FIG. 1A (or vehicle V illustrated in FIG. 2A) spend in average less time on the road surface R1 (or road surface R) than past vehicles that travelled on the road surface R1 (or R), the processing means may determine that the traffic is more fluid than usual.

The distribution of time spent may also be used in combination with known maximum speed limits on the road surface R to determine the average speed of a vehicle. Indeed, as most vehicles drive at a speed near the maximum speed limit, the processing means may determine that time to spent by most vehicles on the road surface R would thus correspond to vehicles driving at the maximum speed limit on the road surface R. Because the speed of a vehicle is inversely proportional to the time spent by the vehicle, the processing means may determine a constant of proportionality by requiring that the maximum speed limit correspond to time to spent by most vehicles on the road surface R. Hence, once the constant of proportionality is known, the system is able, by simply measuring a time difference t2−t1 for a detected vehicle V, to determine the average speed of said detected vehicle V by simply dividing the constant of proportionality by the measured time difference t2−t1. In an alternative embodiment, the processing means may determine the constant of proportionality by requiring that the maximum speed limit correspond to a time greater than t0, for example a time t50 defined as a median time, or any other time defined as any other percentile when taking into account only a portion of the distribution of time spent below t0. For example, time t35 may be defined as a 35th percentile when taking into account only the portion of the distribution of time spent below to, such that a left area AL under the curve (see FIG. 2C) is equal to 35% of the sum of the left area AL and a right area AR under the curve (see FIG. 2C).

The processing means may determine one or more distributions of time spent by one or more classes of road users (e.g., cars, busses, trams, bicycles, pedestrians, etc.) travelling on a road surface. For example, the processing means may determine a distribution of time spent by cars on the road surface, and a distribution of time spent by trucks on the road surface. Since maximum speed limits may be different for different classes of road users, for example 120 km/h for cars and 90 km/h for trucks travelling on a highway, the processing means may determine one or more constants of proportionality corresponding to the one or more classes of road users.

According to the embodiments of FIGS. 2A-2E, and as illustrated in FIG. 2A, the processing means may be configured to detect vehicles V on a road surface R based on the sensed sequence of signals over time, determine two lanes RL1, RL2 of the road surface R in the sensed sequence of signals over time, optionally using the external data, determine within each of the determined two lanes RL1, RL2 a first virtual barrier VB1 and a second virtual barrier VB2, measure for each of the determined two lanes RL1, RL2 a respective time difference t2−t1 between a first time t1 at which a respective detected vehicle V passes the first virtual barrier VB1 and a second time t2 at which the respective detected vehicle V passes the second virtual barrier VB2, and determine a respective average speed of each of the respective detected vehicles V on each of the determined two lanes RL1, RL2 using the external data and the two respective time differences t2−t1.

As illustrated in FIG. 2A, the first virtual barrier VB1 may be the same for each of the determined two lanes RL1, RL2. Likewise, as illustrated in FIG. 2A the second virtual barrier VB2 may be the same for each of the determined two lanes RL1, RL2. In other words, the determined two lanes RL1, RL2 may share a first virtual barrier VB1 and a second virtual barrier VB2.

According to the embodiments of FIGS. 2A-2E, the processing means may be configured to acquire a known average speed from the external data over the determined two lanes RL1, RL2, average the two respective time differences t2−t1 to obtain an average time difference t2−t1_avg over the determined two lanes RL1, RL2, and determine the respective average speed of each of the respective detected vehicles V on each of the determined two lanes RL1, RL2 by comparing the average time difference t2−t1_avg with the known average speed.

According to the embodiments of FIGS. 2A-2E, the processing means may be configured to calibrate the average time difference t2−t1_avg with the known average speed to determine a calibrated distance between the first virtual barrier VB1 and the second virtual barrier VB2, and determine the respective average speed of each of the respective detected vehicles V on each of the determined two lanes RL1, RL2 by dividing the calibrated distance by the respective time difference t2−t1. Said calibrated distance may be determined by e.g. fitting techniques such as a least-square fit or the like.

It should be clear to the skilled person that the above-mentioned configuration of the processing means is not limited to the above-mentioned determined two lanes RL1, RL2 of the road surface R.

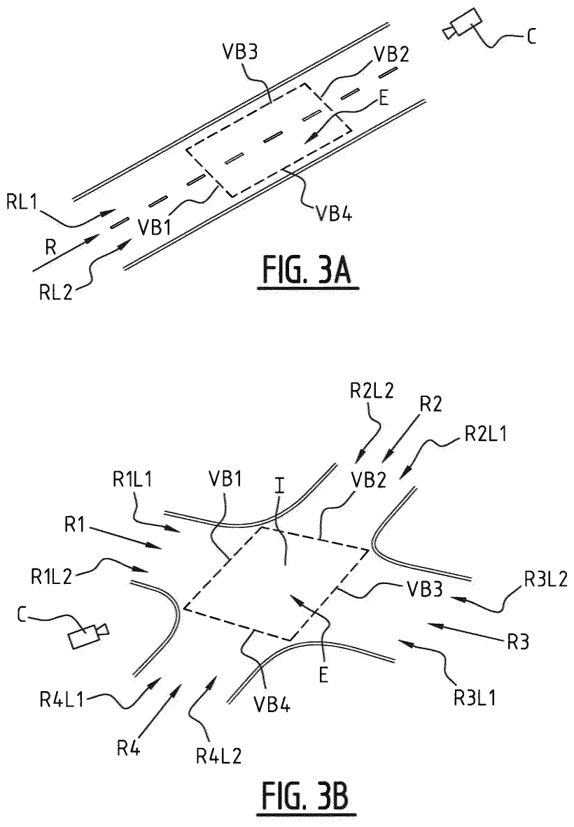

FIGS. 3A-3B illustrate schematically exemplary embodiments of a system for determination of a set of virtual barriers defining an enclosed area within a traffic surface (FIG. 3A) or within a cross-road or cross-traffic intersection (FIG. 3B) according to an exemplary embodiment.

Referring to FIGS. 3A-3B, the processing means may be configured to detect vehicles on a road surface R (FIG. 3A); R1-R4 (FIG. 3B) based on the sensed sequence of signals over time, and determine at least one lane RL1, RL2; R1L1-R4L2 of the road surface R; R1-R4 in the sensed sequence of signals over time, optionally using the external data. Preferably, the processing means may be further configured to receive a position and sensing direction of the sensing means C, and determine the at least one lane RL1, RL2; R1L1-R4L2 of the road surface R; R1-R4 in the sensed sequence of signals over time further using the position and sensing direction.

The processing means may determine a set of virtual barriers VB1-VB4 defining an enclosed area E within the road surface R. The enclosed area E may thus be defined in relation to the determined set of virtual barriers VB1-VB4. The enclosed area E may have a polygonal shape, such as a rectangle as illustrated in FIG. 3A, wherein each side of the polygon corresponds to one virtual barrier of the determined set of virtual barriers VB1-VB4.

Referring to FIG. 3A, a single virtual barrier VB1; VB2 is determined for adjacent lanes RL1; RL2 of the plurality of determined lanes RL1, RL2, the single virtual barrier VB1; VB2 forming one side of the rectangle. The processing means may determine a first virtual barrier VB1 that may be a virtual line segment that is perpendicular to a first boundary of the road surface R and to a second boundary of said road surface R that is different from the first boundary, in order to detect vehicles travelling on the road surface R. In a similar manner, the processing means may determine a second virtual barrier VB2 that is different from the first virtual barrier VB1. The processing means may further determine a third virtual barrier VB3 and a fourth virtual barrier VB4 by joining the extremities of the first virtual barrier VB1 and the second virtual barrier VB2, so that the set of virtual barriers VB1-VB4 defines a rectangular enclosed area E within the road surface R.

Alternatively or in addition, the processing means may determine a set of virtual barriers VB1-VB4 defining an enclosed area E, such as a square as illustrated in FIG. 3B, within a cross-road intersection I, wherein the cross-road intersection I may correspond to an intersection between any number of road surfaces. FIG. 3B shows road surfaces R1-R4, lanes R1L1, R1L2 corresponding to road surface R1, lanes R2L1, R2L2 corresponding to road surface R2, lanes R3L1, R3L2 corresponding to road surface R3, and lanes R4L1, R4L2 corresponding to road surface R4.

Referring to FIG. 3B, the processing means may determine a virtual barrier at each boundary between one of the road surfaces R1-R4 and the cross-road intersection I. For example, the processing means may determine a first virtual barrier VB1 located at one side of the cross-road intersection I, wherein the first virtual barrier VB1 may be a virtual line segment that is perpendicular to a first boundary of the road surface R1 and to a second boundary of said road surface R1 that is different from the first boundary, in order to detect vehicles travelling from the cross-road intersection I to the road surface R1 and vice versa. The processing means may determine the virtual barriers VB2-VB4 in a similar manner, so that the set of virtual barriers VB1-VB4 defines an enclosed area E within the cross-road intersection I.

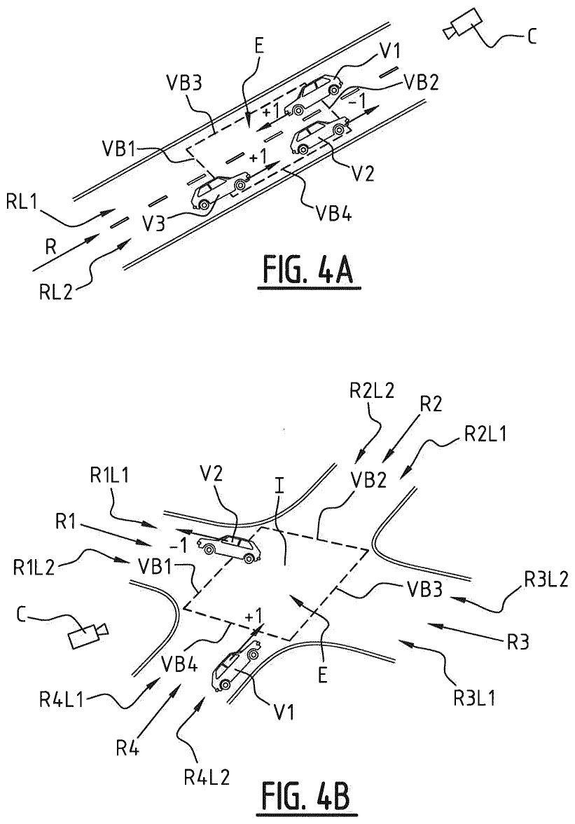

FIGS. 4A-4B illustrate schematically exemplary embodiments of a system for counting a number of vehicles driving through an enclosed area within a road surface (FIG. 4A) or within a cross-road intersection (FIG. 4B) according to an exemplary embodiment.

Referring to FIGS. 4A-4B, the processing means may be configured to detect vehicles V1-V3 on a road surface R (FIG. 4A); R1-R4 (FIG. 4B) based on the sensed sequence of signals over time, and determine at least one lane RL1, RL2; R1L1-R4L2 of the road surface R; R1-R4 in the sensed sequence of signals over time, optionally using the external data. Preferably, the processing means may be further configured to receive a position and sensing direction of the sensing means C, and determine the at least one lane RL1, RL2; R1L1-R4L2 of the road surface R; R1-R4 in the sensed sequence of signals over time further using the position and sensing direction.

As illustrated in the embodiment of FIG. 4A, the processing means may be configured to determine a set of virtual barriers VB1-VB4 within the determined at least one lane RL1, RL2 defining together an enclosed area E within the road surface R (see FIG. 3A and related description), and to determine a difference between vehicles V1 and V3 entering the enclosed area E and vehicle V2 exiting said enclosed area E. It is noted that the above disclosure also applies to the cross-road intersection I of FIG. 4B, the latter showing vehicles V1, V2, road surfaces R1-R4, lanes R1L1, R1L2 corresponding to road surface R1, lanes R2L1, R2L2 corresponding to road surface R2, lanes R3L1, R3L2 corresponding to road surface R3, and lanes R4L1, R4L2 corresponding to road surface R4 (see FIG. 3B and related description).

The processing means may be further configured to assign a +1 value to each vehicle entering the enclosed area E, to assign a −1 value to each vehicle exiting the enclosed area E, and to determine the difference by summing all values assigned to said vehicles. Referring to FIG. 4A, the processing means may assign a +1 value to vehicles V1 and V3 entering the enclosed area E, and may assign a −1 value to vehicle V2 leaving the enclosed area E. The processing means may determine a difference equal to +1 by summing all values assigned to the vehicles entering or leaving the enclosed area. Referring to FIG. 4B, the processing means may assign a +1 value to vehicle V1 entering the enclosed area E, and may assign a −1 value to vehicle V2 leaving the enclosed area E. The processing means may determine a difference equal to 0 by summing all values assigned to the vehicles entering or leaving the enclosed area.

The enclosed area E may be defined so as to determine a traffic difference in the road surface R or in the cross-road intersection I. By doing so, the processing means may detect long-lasting differences and/or detect presence or absence of vehicles in the enclosed area. For example, it may be used to detect road situations such as traffic jams, wherein differences between vehicles entering the enclosed area E and vehicles exiting said enclosed area E are expected to last longer than other situations wherein the traffic is fluid. The processing means may measure a time of differences, defined as a time interval between a first time at which differences started and a second time at which the difference returned to 0. If the time of differences is greater than a threshold value, the processing means may determine that there is a traffic jam in the road surface R or in the cross-road intersection I. The processing means may also track the differences over time, and determine a severity of the traffic jam based on the differences value. For example, a road surface wherein differences fluctuate around e.g. 20 may correspond to a more severe traffic jam than another road surface wherein differences fluctuate around e.g. 5. The enclosed area E may also be used to ensure there are no more vehicles in a lane whose direction is reversible before reversing the direction of circulation.

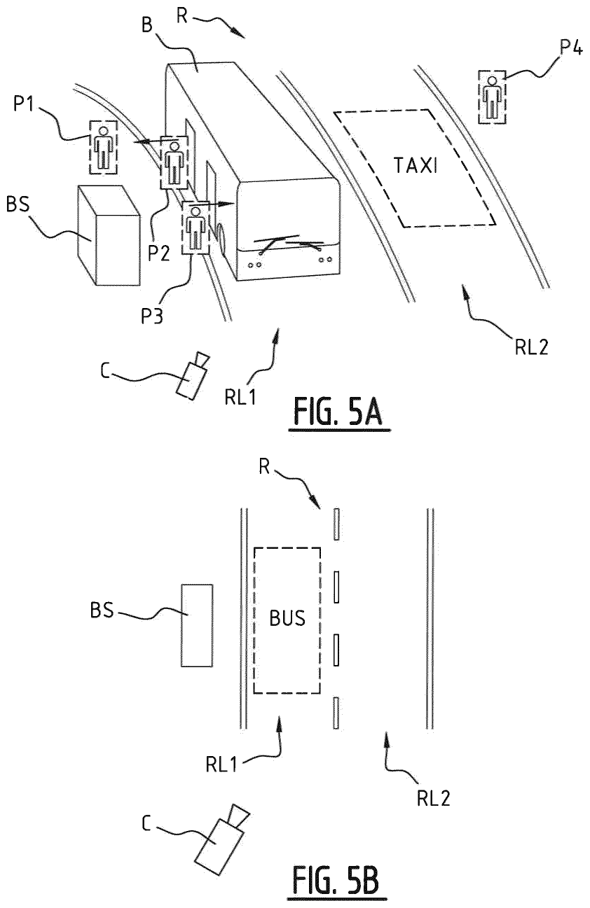

FIGS. 5A-5B illustrate schematically exemplary embodiments of a system for determination of an amount of detected persons that enter or exit a stationary vehicle according to an exemplary embodiment.

The processing means may be configured to detect a stationary vehicle B on the road surface R based on the sensed sequence of signals over time, to detect persons P1-P3 in a portion of the area that surrounds the stationary vehicle B based on the sensed sequence of signals over time, and to determine an amount of detected persons P2, P3 in the sensed sequence of signals over time that enter or exit the stationary vehicle B. Optionally, the processing means may be configured to receive a position and sensing direction of the sensing means C.

Referring to FIG. 5A, the sensing means C may sense a sequence of signals over time related to an area comprising a road surface R. The road surface R may comprise a first lane RL1 and a second lane RL2. The external data may comprise a map comprising the area (see FIG. 5B), and in particular a map comprising the road surface R. The map may contain relative positions and dimensions of various static infrastructure elements, such as a bus stop BS (see FIG. 5B). The processing means may receive the map of the area comprising the various static infrastructure elements, recognize those elements on the sensed sequence of signals over time and determine which portions of the signals belong to those elements. The position and sensing direction of the sensing means C may be used to perform this fitting accurately. In exemplary embodiments wherein the sensing means C comprises an image capturing means, the processing means may receive the map of the area comprising the various static infrastructure elements, recognize those elements on the captured sequence of images over time and determine which pixels belong to those elements. The position and viewing direction of the image capturing means may be used to perform this fitting accurately. The processing means may detect other static elements not present in the received map of the area, such as a taxi stop marking (see FIG. 5A). The processing means may also detect moving objects, such as a bus B and pedestrians P1-P4, and determine a minimum bounding box around those objects, wherein the bounding box, in this example, is rectangular and encloses an object in a 2D image.

The processing means may detect the bus B stopping at the bus stop BS, detect persons P1-P3 at the bus stop BS, determine that the number of persons that enter the bus B is equal to 1, and determine that the number of persons that exit the bus B is equal to 1. Indeed, the person P3 is entering the bus B and the person P2 is exiting the bus B (see FIG. 5A). Therefore, the system may not only determine traffic flow information related to objects such as vehicles on a road surface R, but may also determine traffic flow information related to objects such as pedestrian P4 or public transport users P1-P3 in a pathway, such as a sidewalk or zebra crossing of the road surface R. In this way, traffic flow information about the entire area comprising the road surface R may be determined. Also, compliance of traffic laws involving different classes of objects may be monitored, e.g. the processing means may yield an alert and/or identify a license plate of a vehicle if said vehicle did not stop before a pedestrian crossing in the presence of pedestrians waiting to cross the pedestrian crossing.

The processing means may be configured to detect persons P1-P4 in a portion of the area that surrounds the road surface R based on the sensed sequence of signals over time, and determine an amount of detected persons in the sensed sequence of signals over time. Referring to FIG. 5A, the processing means may detect persons P1-P4 in a pathway such as a sidewalk or a zebra crossing of the road surface R, and determine the amount of detected persons in the pathway to estimate pedestrian traffic in the area.

The external data may comprise a schedule of public transportation. The processing means may receive the schedule of public transportation and may determine if the bus B is on time. Further, the processing means may take into account the schedule of public transportation in order to determine traffic flow information related to persons in the sensed sequence of signals over time.

The external data may comprise information pertaining to regulations for persons in the area (e.g. wearing a face mask, staying at a distance from another person, etc.) and/or information pertaining to symptoms of a disease. The processing means may determine if a person among the persons P1-P4 may present certain symptoms of any disease, e.g. by examining a facial expression (narrowed eyes, etc.), a gesture (sneezing, coughing, unusual movements, etc.), or an inappropriate behavior (dropping used tissue or used sanitary mask, etc.) of said person.

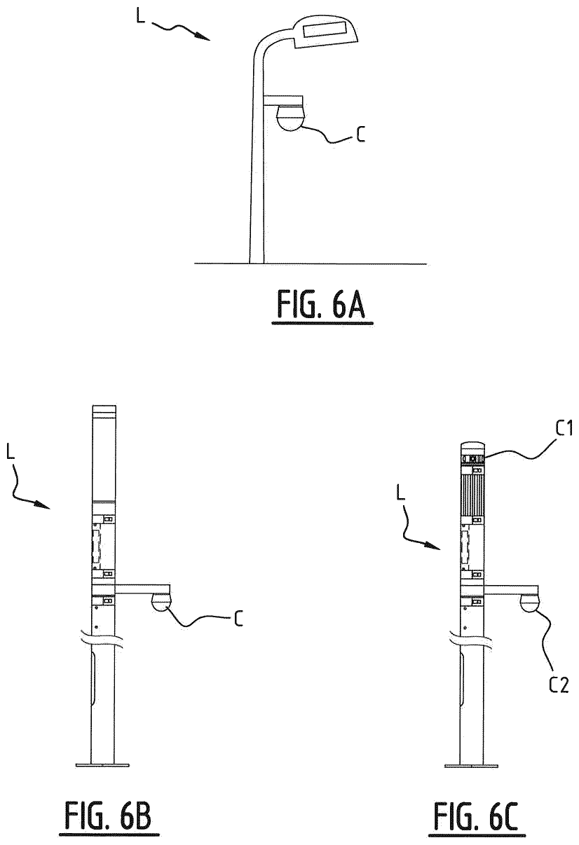

FIGS. 6A-6C illustrate schematically exemplary embodiments of a system according to an exemplary embodiment which is provided on a luminaire.

As illustrated in the embodiments of FIGS. 6A-6C, one or more luminaires L may comprise the system for determination of traffic flow information in an area, in particular an area comprising a road surface, as described in the above-mentioned embodiments. Referring to FIG. 6A, the luminaire L may comprise a pole and a luminaire head connected to a top end of the pole. The sensing means C may be provided in or on the luminaire L, e.g. on the pole of the luminaire L (see FIG. 6A). The sensing means C may also be included in the luminaire head of the luminaire L. Exemplary embodiments of sensing means included in the luminaire head are disclosed in PCT publication WO 2019/243331 A1 in the name of the applicant, which is included herein by reference.

As illustrated in the embodiments of FIGS. 6B-6C, the luminaire L may comprise a plurality of pole modules arranged one above the other, and the sensing means C may be arranged in or on a pole module of said plurality of pole modules. For example, the sensing means C may be connected to a pole module of the luminaire L through a bracket (see FIG. 6B). Referring to FIG. 6C, the luminaire L may comprise a first sensing means C1 and a second sensing means C2. The first sensing means C1 may be provided in one of the plurality of pole modules and may comprise multiple sensing means, for example four sensing means facing different direction so as to cover an area around 360°. The second sensing means C2 may be connected to a pole module of the luminaire L through a bracket, as in the embodiment of FIG. 6B. Exemplary embodiments of pole modules comprising multiple sensing means facing different direction are disclosed in PCT publication WO 2021/094612 A1 in the name of the applicant, which is included herein by reference.

A network of luminaires may comprise one or more luminaires L as described in the above-mentioned embodiments. In this way, the traffic flow information may reach a remote entity, such as a local or a global road authority, so that the network can send signals pertaining to (real-time) monitoring of the traffic in said area. If needed, warning signals can be sent in case of a dangerous or potentially dangerous traffic situation. The network of such luminaires may also be used to warn road users of other areas, such as neighboring areas, that a particular traffic situation such as an accident or a traffic jam occurs in the area. In order to do so, at least one luminaire L of the network should be provided with such a system. However, it is not required that all luminaires of the network be provided with such a system, although efficiency and accuracy of the traffic info determination may be increased. Data sensed by the respective sensing means of the one or more luminaires L may be combined. By doing so, measurement resolution, accuracy, precision and error rates may be improved. Additionally combining data from sensors associated with multiple luminaires at different locations may make it possible to determine results not achievable by measurements performed by a single luminaire. Exemplary embodiments of luminaire networks are disclosed in PCT publication WO 2019/175435 A2 in the name of the applicant, which is included herein by reference.

Whilst the principles of the invention have been set out above in connection with specific embodiments, it is to be understood that this description is merely made by way of example and not as a limitation of the scope of protection which is determined by the appended claims.

1. A system for determination of traffic flow information in an area comprising a traffic surface, such as a road surface or a pedestrian surface, said system comprising:
a sensing means configured to sense a sequence of signals over time related to the area; and
a processing means configured to:
receive the sensed sequence of signals over time and optionally external data related to the area;
detect moving objects in the area based on the sensed sequence of signals over time; and
determine traffic flow information related to said moving objects in the sensed sequence of signals over time optionally using the external data.

2. The system of claim 1, wherein the processing means is configured to determine traffic flow information by determining a model, optionally based on the external data; and determining the traffic flow information related to said moving objects in the sensed sequence of signals over time using the model; and
wherein preferably the processing means is configured to receive new and/or updated external data related to the area and to update the model based on the new and/or updated external data.

3. (canceled)

4. The system of claim 1, wherein the sensing means comprises any one of the following: an image capturing means configured to capture a sequence of images, such as a visible light camera or a thermal camera, a LIDAR configured to capture a sequence of point clouds, a radar, a receiving means with an antenna configured to capture a sequence of signals, in particular a sequence of short-range signals, such as Bluetooth signals, a sound capturing means, or a combination thereof.

5. The system of claim 1, wherein the sensing means is configured to sense signals of the sequence of signals over time at consecutive time intervals, preferably at least two signals per second, more preferably at least 10 signals per second; and/or
wherein the sensing means comprises an image capturing means configured to capture a sequence of images related to the area at consecutive time intervals, preferably at least two frames per second, more preferably at least 10 frames per second, said sequence of images preferably comprising images of at least one lane of the road surface and/or images of the pedestrian surface.

6. (canceled)

7. The system of claim 1, wherein the external data comprises any one or more of the following: a map comprising the area, in particular a map comprising the traffic surface, a layout of the area, in particular a layout of the traffic surface, information pertaining to the area, in particular information pertaining to at least one lane of the road surface and/or information pertaining to the pedestrian surface, a geographic location of the area, a type of the area, a geographic location of street furniture in the area, an average speed of vehicles in one or more of at least one lane of the road surface, an average number and/or speed of pedestrians in the pedestrian surface, real-time traffic in the area, real-time information pertaining to traffic lights, information pertaining to traffic laws in the area, information pertaining to a type of landscape in the area, weather data, road and/or pedestrian surface condition data, a time schedule of objects moving in the area.

8. The system of claim 1, wherein the processing means is configured to receive the external data from any one or more of the following external sources: Geographic Information Systems, GIS, local authorities of a city, mobile devices of users of a navigation system, a database of a navigation system, toll stations, mobile communications, Radio Data System-Traffic Message Channel, RDS-TMC, traffic messages, a database containing information about traffic events.

9. The system of claim 1, wherein the processing means is configured to:
detect one or more infrastructure elements in the area based on the sensed sequence of signals over time; and
determine the one or more infrastructure elements in the sensed sequence of signals over time optionally using the external data;
wherein preferably the processing means is configured to:
receive a position and sensing direction of the sensing means; and
determine the one or more infrastructure elements in the sensed sequence of signals over time using the position and sensing direction;
wherein preferably the external data comprises a map of the area, and the processing means is configured to determine the one or more infrastructure elements by adjusting the map to the sensed sequence of signals over time using the position and sensing direction of the sensing means.

10-11. (canceled)

12. The system of any one of previous claim 1, wherein the processing means is configured to:
determine at least one virtual barrier within the traffic surface; and
count a number of detected moving objects crossing the at least one virtual barrier.

13. The system of any one of previous claim 1, wherein the processing means is configured to:
determine a set of virtual barriers defining together an enclosed area within the traffic surface; and
determine a difference between moving objects entering the enclosed area and moving objects exiting said enclosed area;
wherein preferably the processing means is configured to:
assign a +1 value to moving objects entering the enclosed area;
assign a −1 value to moving objects exiting the enclosed area; and
determine the difference by summing all values assigned to said moving objects.

14. (canceled)

15. The system of claim 1, wherein the processing means is configured to:
detect vehicles on the road surface based on the sensed sequence of signals over time; and
determine at least one lane of the road surface in the sensed sequence of signals over time, optionally using the external data.

16. The system of claim 15, wherein the processing means is configured to determine if a lane of the determined at least one lane has a side turn optionally using the external data, and if yes, determine a first virtual barrier before the side turn and a second virtual barrier AB after the side turn.

17. The system of claim 15, wherein the processing means is configured to:
determine at least one first virtual barrier within the determined at least one lane;
determine at least one second virtual barrier within the determined at least one lane;
measure a time difference between a first time at which a detected vehicle passes one of the at least one first virtual barrier and a second time at which the detected vehicle passes one of the at least one second virtual barrier; and
determine an average speed of the detected vehicle using the external data and the time difference;
wherein preferably the processing means is configured to:
determine a calibration function using a set of known average speeds from the external data and a set of measured time differences corresponding to the set of known average speeds; and
determine the average speed of the detected vehicle using the calibration function.

18. (canceled)

19. The system of claim 15, wherein the processing means is configured to:
determine at least one virtual barrier within the determined at least one lane; and
determine when a detected vehicle passes the at least one virtual barrier.

20. The system of claim 15, wherein the determined at least one lane comprises at least two determined lanes;
wherein the processing means is configured to:
determine within each of the determined at least two lanes a first virtual barrier and a second virtual barrier;
measure for each of the determined at least two lanes a respective time difference between a first time at which a respective detected vehicle passes the first virtual barrier and a second time at which the respective detected vehicle passes the second virtual barrier; and
determine a respective average speed of each of the respective detected vehicles on each of the determined at least two lanes using the external data and the at least two respective time differences.

21. The system of claim 20, wherein the processing means is configured to:
acquire a known average speed from the external data over the determined at least two lanes;
average the at least two respective time differences to obtain an average time difference over the determined at least two lanes; and
determine the respective average speed of each of the respective detected vehicles on each of the determined at least two lanes by comparing the average time difference with the known average speed;
wherein preferably the processing means is configured to:
calibrate the average time difference with the known average speed to determine a calibrated distance between the first virtual barrier and the second virtual barrier; and
determine the respective average speed of each of the respective detected vehicles on each of the determined at least two lanes by dividing the calibrated distance by the respective time difference.

22. (canceled)

23. The system of claim 15, wherein the processing means is configured to:
receive a position and sensing direction of the sensing means; and
determine the at least one lane of the road surface in the sensed sequence of signals over time further using the position and sensing direction;
and/or wherein the processing means is configured to determine a type of each of the determined at least one lane optionally using the external data; and/or
wherein the processing means is configured to associate each of the detected vehicles with a corresponding lane of the determined at least one lane, wherein preferably the processing means is configured to classify portions of the signals belonging to each of the detected vehicles in the sensed sequence of signals over time into respective lanes of the determined at least one lane; and/or
wherein the processing means is configured to determine a movement direction of the detected vehicles within the determined at least one lane.

24-26. (canceled)

27. The system of claim 23, wherein the external data comprises a map comprising the at least one lane, and the processing means is configured to determine the at least one lane by adjusting the map to the sensed sequence of signals over time using the position and sensing direction of the sensing means.

28. (canceled)

29. The system of claim 1, wherein the processing means is configured to:
detect one or more persons on the pedestrian surface based on the sensed sequence of signals over time; and
determine traffic flow information related to said one or more persons in the sensed sequence of signals over time optionally using the external data.

30. The system of claim 29, wherein the processing means is configured to:
receive a position and sensing direction of the sensing means; and
determine the traffic flow information related to said one or more persons in the sensed sequence of signals over time using the position and sensing direction;
wherein preferably the external data comprises a map of the pedestrian surface, and the processing means is configured to determine the one or more persons by adjusting the map to the sensed sequence of signals over time using the position and sensing direction of the sensing means.

31. (canceled)

32. The system of claim 1, wherein the processing means is configured to:
detect a stationary vehicle on the road surface based on the sensed sequence of signals over time;
detect persons in a portion of the area that surrounds the stationary vehicle based on the sensed sequence of signals over time; and
determine an amount of detected persons in the sensed sequence of signals over time that enter or exit the stationary vehicle; and/or
wherein the processing means is configured to:
detect persons in a portion of the area that surrounds the road surface based on the sensed sequence of signals over time; and
determine an amount of detected persons in the sensed sequence of signals over time; and/or
wherein the processing means is configured to:
detect persons on the pedestrian surface based on the sensed sequence of signals over time; and
determine an amount of detected persons in the sensed sequence of signals over time.

33-37. (canceled)
